(19) United States
(12) Patent Application Publication
(10) Pub. No.: US 2009/0263625 A1
(43) Pub. Date: Oct. 22, 2009

(54) DECORATIVE PART FOR A MOTOR VEHICLE, COMPRISING AN OPENING AND A SUPPORTING ELEMENT

(75) Inventors: Ingo Zippel, Kerpen (DE); Benoit Colombain, Haguenau (FR)

Correspondence Address: FOLEY AND LARDNER LLP;SUITE 500, 3000 K STREET NW, WASHINGTON, DC, 20007, US

(73) Assignee: Johnson Controls Headliner GmbH

(21) Appl. No.: 12/282,870

(22) PCT Filed: Mar. 12, 2007
(86) PCT No.: PCT/EP07/02147

§ 371 Date: Feb. 25, 2009

(30) Foreign Application Priority Data
Mar. 15, 2006 (DE) 10 2006 012 252.6

(51) Int. Cl. B32B 3/10

(52) U.S. Cl. 428/137

(57) ABSTRACT

The invention relates to a decorative part for a motor vehicle, especially for the inside of a motor vehicle. Said decorative part comprises a visible side and a rear side, in addition to a carrier. According to the invention, the decorative part comprises a decorative material on the visible side thereof and the carrier comprises an opening, the decorative material being turned up in the region of the opening on the rear side of the decorative part, forming a doubled-back edge. Furthermore, a supporting element connected to the carrier is provided in the region of the opening, said supporting element being used to form the doubled-back edge of the decorative material.

The present invention relates to a decorative part for a motor vehicle, in particular an interior decorative part of a motor vehicle, the decorative part having a visible side and a rear side, the decorative part comprising a carrier, the decorative part having a decoration material on the visible side, the carrier having an opening, and the decoration material being provided, bent round so as to form a bend-round edge, in the region of the opening on the rear side of the decorative part.

Such decorative parts are generally known in motor vehicle construction, in particular for making openings for electric sliding roofs. For example, it is known from Patent Specification DE 32 22 419 C1 to configure a roof structure for motor vehicles with a sliding roof in a special way such that the stability of the roof structure is not lowered due to the sliding roof. In known set-out parts for a motor vehicle, it is customary to produce an opening in a carrier material for inside roof linings and subsequently to bend a decoration material, for example an upholstered cloth or synthetic leather material or the like, around the opening introduced into the carrier part material, so that the transition between the inside roof lining and the sliding roof can have as aesthetically pleasing a configuration as possible. The problem in previous decorative parts for motor vehicles is that the openings, for example for sliding roofs, in the carrier material for stabilizing the inside roof lining can be produced efficiently and cost-effectively only when there is a generous tolerance, and therefore, when the frame for the sliding roof is inserted, unacceptable inaccuracies arise with regard to the dimensional tolerance between the interior decorative part and the sliding roof. To solve this problem, it was proposed in the prior art to increase the accuracy with which the opening is introduced into the carrier material of the inside roof lining. This, however, entails considerable extra costs either due to the use of special machines or else because reworking to be carried out manually has to be formed on the opening of the inside of the roof lining.

The object of the present invention, therefore, is to provide a decorative part for a motor vehicle, which decorative part has an opening which, at a low cost outlay, implements a considerably higher dimensional accuracy for the dimensions of the opening than was possible according to the prior art.

This object is achieved by means of a decorative part for a motor vehicle, in particular an interior decorative part of a motor vehicle, the decorative part having a visible side and a rear side, the decorative part comprising a carrier, the decorative part having a decoration material on the visible side, the carrier having an opening, and the decoration material being provided, bent round so as to form a bend-round edge, in the region of the opening on the rear side of the decorative part, furthermore a supporting element connected to the carrier being provided in the region of the opening, the supporting element being provided so as to form the bend-round edge of the decoration material. It is thereby advantageously possible, according to the invention, that, on the one hand, for by far the largest part of the surface of the decorative part, it is possible for the carrier to be a stabilizing element of the decorative part, along with all the advantages in terms of weight or the like, and nevertheless a high dimensional tolerance or dimensional accuracy can be achieved in the region of the opening due to the connection of the carrier to the supporting element. As a result, a highly efficient and cost-effective implementation of a decorative part for a motor vehicle, in particular an inside roof lining of a vehicle in the region of an opening for a vehicle sliding roof, is possible.

According to the invention, it is preferable that the supporting element be provided peripherally in the form of a frame at the opening. As a result, the mounting of the supporting element, on the one hand, is possible at only a low outlay and, on the other hand, is possible with very high positioning accuracy, because a single positioning of the supporting element in relation to this carrier is necessary in order to achieve the exact definition of the opening. Furthermore, the decorative part is reinforced mechanically in the region of the opening by a supporting element provided in the form of a frame.

According to the invention, further, it is preferable that the supporting element be provided from a first material and the carrier of the decorative part be provided from a second material, customary dimensional tolerances being lower for the first material than for the second material. A considerable gain in accuracy, using the supporting element, can thereby be achieved in the region of the opening. Preferably, the first material is a metal material, in particular a stamped metal material, for example sheet steel or the like, which can be produced by established production methods with very high dimensional accuracy or with the low tolerances in terms of dimensioning. Furthermore, it is preferable that the second material be a plastic material, preferably with a fiber fraction of natural and/or synthetic fibers. The second material is, for example, a composite material with a plastic fraction and with a fraction produced from natural or renewable raw materials.

According to the invention, furthermore, it is preferable that a tolerance compensation clearance be provided between the margin of the carrier in the region of the opening and the supporting element. It is thereby advantageously possible, according to the invention, that the accuracy achievable overall is improved considerably, even though the tolerances in the shaping of, for example, the carrier for the decorative part are comparatively high, thus leading to a cost-effective production possibility. Furthermore, according to the invention, it is preferable that the decoration material have an upholstery layer, so that the tolerance compensation clearance can be bridged without any aesthetic impairment.

According to the invention, furthermore, it is preferable that the supporting element be provided so as to be essentially L-shaped in cross section. A particularly simple shaping of the supporting element is thereby possible, this contributing to a cost-effective production of the supporting element and consequently, overall, of the decorative part.

The invention is explained in more detail below by means of exemplary embodiments illustrated in the drawing in which:

FIG. 1 shows a sectional illustration through a decorative part according to the invention in the region of an opening,

FIG. 2 shows a sectional illustration in the region of the opening through a diagrammatically illustrated decorative part, with the entire opening,

FIG. 3 shows a diagrammatic illustration of a top view of a motor vehicle roof with a decorative part according to the invention, and

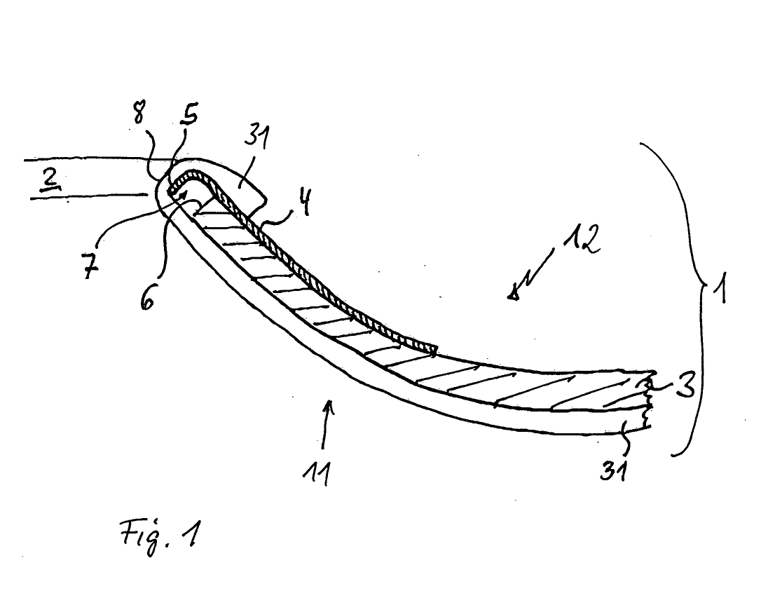

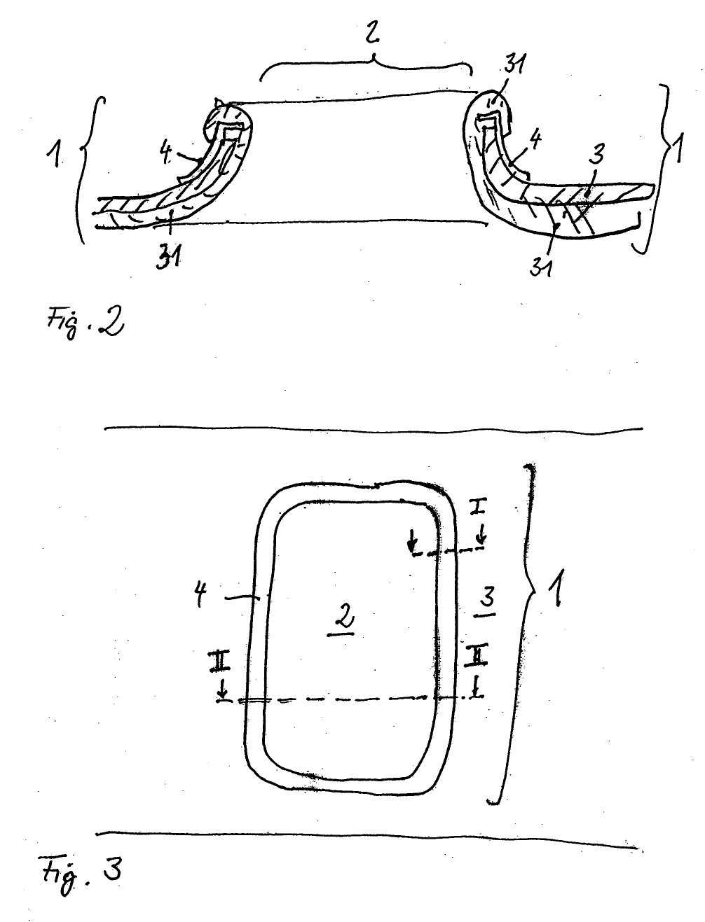

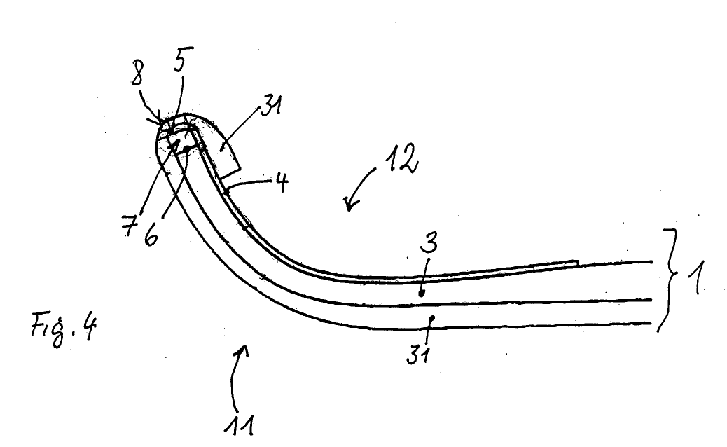

FIG. 4 shows a further sectional illustration through the decorative part in the region of the opening in the decorative part.

FIGS. 1 and 4 illustrate diagrammatically a sectional illustration of a decorative part 1 according to the invention. The decorative part 1 has a carrier 3 which is also designated as a carrier part or as a carrier molding. The carrier 3 is produced, in particular, from a second material which is optimized for the intended uses of the decorative part 1 and which, in particular, is comparatively lightweight and, furthermore, has other requirements, such as, for example, low flammability or the like. The carrier 3 is provided as a basis for the aesthetically satisfactory arrangement of a decoration material 31 which is attached to a visible side 11 of the carrier 3. Furthermore, the carrier 3 has a rear side 12 on the side lying opposite the visible side 11. The carrier 3, moreover, has an opening 2 which, in particular, is provided peripherally within the carrier 3. According to the invention, however, there may also be provision for the opening to be located at a margin of the carrier 3. In the region of the opening 2, the carrier 3 has a margin 6 or cut edge 6. The opening 2 is introduced into the carrier 3 and consequently into the decorative part 1 through the cut edge 6 or through the margin 6.

According to the invention, then, the second material of the carrier 3 can be produced with a low dimensional tolerance or with high dimensional accuracy only at relatively high outlay. This is, for example, to do with the fact that the material used for the carrier 3 may still undergo distortion or suchlike changes in shape during the further production process. For this reason, at least in economic terms, it is not expediently possible to employ only the edge 6 in order to define the dimensions of the opening 2. According to the invention, there is provision for a supporting element 4 to be connected to the carrier 3 in the region of the opening 2. This connection may be provided, for example, via conventional connection techniques, such as riveting, screwing, adhesive bonding or the like. Furthermore, it is also possible that the supporting element 4 is, for example, incorporated directly into the process of shaping the carrier 3, for example is introduced directly into a mold for shaping the carrier 3 and, during the final shaping of the carrier 3, is fastened or connected to the latter. According to the invention, there is provision for a gap 7 for tolerance compensation to remain between the margin 6 or the cut edge 6 of the carrier 3 and a front edge 5 of the supporting element 4, which gap may be of greater or lesser size, depending on the actual dimensions of the margin 6 or of the cut edge 6 of the carrier 3. The gap 7 is also designated below as a tolerance compensation clearance 7. According to the invention, the supporting element 4 is produced from a first material or has essentially completely a first material. This first material is provided, in particular, as a metal material, in particular as a sheet metal pressed part or the like, which can be produced at comparatively low outlay and by means of established technologies with, as compared with the dimensional accuracy of the carrier 3, a considerably lower dimensional tolerance or a considerably higher accuracy in terms of its dimensions. As a result, the front edge 5 of the supporting element is ultimately employed to define the opening 2 exactly in terms of its dimensions. The decoration material 31 is bent around this front edge 5 of the supporting element 4 in the region of the opening 2. This gives rise to an aesthetically pleasing transition between the decorative part 1 and, for example, the electric sliding roof which is inserted into the opening 2.

According to the invention, it may advantageously be possible to equip the decoration material 31 with an upholstery layer, not illustrated in FIGS. 1 and 4, such as, for example, a foam layer or the like. This foam layer or upholstery layer is then to be presented as part of the decoration layer or decoration material 31 in the region between the decoration material 31 and the carrier part 3.

The supporting element 4 is bent, in particular, in an L-shaped manner in the region of its front edge 5 in such a way that the bend-round or the bend-round edge 8 is possible without the decoration material 31 at the front edge 5 of the supporting element 4 being destroyed, in such a way that the decoration material 31 can be fastened to the rear side 12 effectively and reliably in order to form the bend-round or bend-round edge 8.

FIG. 3 illustrates a diagrammatic top view of a vehicle roof with an opening 2 which is introduced in an inside roof lining 1, illustrated as an example of a decorative part 1 of a motor vehicle. The supporting element 4 is illustrated diagrammatically, running peripherally in the form of a frame around the opening 2.

FIG. 2 illustrates a further sectional illustration through the decorative part 1, both sides of the opening 2 being taken into account in the sectional illustration.

The illustration of FIG. 2 may be interpreted as a section along the section line II, while the illustration of FIG. 1 or of FIG. 4 may be interpreted as a sectional illustration along the section line I in FIG. 3.

### LIST OF REFERENCE SYMBOLS

1 Decorative part
2 Opening
3 Carrier
4 Supporting element
5 Front edge
6 Margin
7 Tolerance compensation clearance
8 Bend-round edge
11 Visible side
12 Rear side
31 Decoration material

1. A decorative part for a motor vehicle, in particular an interior decorative part of a motor vehicle, the decorative part having a visible side and a rear side, the decorative part comprising a carrier, the decorative part having a decoration material on the visible side, the carrier having an opening, and the decoration material being provided, bent round so as to form a bend-round edge, in the region of the opening on the rear side of the decorative part, characterized in that a supporting element connected to the carrier is provided in the region of the opening, the supporting element being provided so as to form the bend-round edge of the decoration material.

2. The decorative part as claimed in claim 1, characterized in that the supporting element is provided peripherally in the form of a frame at the opening.

3. The decorative part as claimed in claim 1, characterized in that the supporting element is provided from a first material and the carrier of the decorative part is provided from a second material, customary dimensional tolerances being lower for the first material than for the second material.

4. The decorative part as claimed in claim 1, characterized in that tolerance compensation clearance is provided between the margin of the carrier in the region of the opening and the supporting element.

5. The decorative part as claimed in claim 1, characterized in that the supporting element is provided so as to be essentially L-shaped in cross section.

6. The decorative part as claimed in claim 1, characterized in that the first material is a metal material, in particular stamped metal material.

7. The decorative part as claimed in claim 1, characterized in that the second material is a plastic material, preferably with a fiber fraction of natural or synthetic fibers.

8. The decorative part as claimed in claim 1, characterized in that the decorative part is an inside roof lining of a vehicle.

9. The decorative part as claimed in claim 1, characterized in that the opening is an opening for a vehicle sliding roof.
